(19) United States
(12) Patent Application Publication
(10) Pub. No.: US 2016/0300325 A1
(43) Pub. Date: Oct. 13, 2016

(54) ELECTRONIC APPARATUS, METHOD OF CONTROLLING ELECTRONIC APPARATUS AND NON-TRANSITORY STORAGE MEDIUM

(71) Applicant: NEC CORPORATION, Tokyo (JP)

(72) Inventor: Teruya IKEGAMI, Tokyo (JP)

(73) Assignee: NEC Corporation, Tokyo (JP)

(21) Appl. No.: 15/026,864

(22) PCT Filed: May 8, 2014
(86) PCT No.: PCT/JP2014/062359

§ 371 Date: Apr. 1, 2016

(30) Foreign Application Priority Data
Oct. 4, 2013 (JP) 2013-208808

(51) Int. Cl. G06T 3/60; G09G 5/14

(52) U.S. Cl. CPC G06T 3/60; G09G 5/14; G09G 2340/0492

(57) ABSTRACT

Provided is an electronic apparatus (10) that includes a display unit (11) that displays on a display a first screen on which a plurality of sub-areas are arranged, a reception unit (12) that receives instruction inputs to change orientations of the sub-areas included in the first screen into a specified state in unit of sub-area, a determination unit (13) that determines whether or not a layout of the plurality of the sub-areas satisfies a first condition on a screen after the orientation of a specific one of the sub-areas which is included in the first screen is changed into the specified state without a positional change according to the instruction input, and a screen change unit (14) that changes the orientation of the specific one of the sub-areas included in the first screen which is displayed on the display into the specified state according to the instruction input and changes the layout of the plurality of sub-areas so as to satisfy the first condition, when the determination unit determines that the first condition is not satisfied.

### TECHNICAL FIELD

The present invention relates to an electronic apparatus, a method of controlling an electronic apparatus, and a program.

### BACKGROUND ART

Patent Document 1 discloses a display apparatus capable of displaying, on a display, a screen which includes a plurality of sub-areas and changing the orientation of each sub-area without a positional change. Changing the orientation of a sub-area without a positional change corresponds to rotating the sub-area around a predetermined point (for example, a center point) within the sub-area to change the orientation thereof.

### RELATED DOCUMENT

### Patent Document

[Patent Document 1] Pamphlet of International Publication No. WO97/35248

### SUMMARY OF THE INVENTION

### Technical Problem

The present inventor found a new problem to be solved in a technique which is capable of changing the orientation of each sub-area without a positional change on a screen which includes a plurality of sub-areas. Hereinafter, the description will be made with reference to FIGS. 8 to 10.

FIG. 8 illustrates two users who face each other with a desk 20 interposed therebetween. For example, a user 1 is a salesman and a user 2 is a customer. An electronic apparatus 30 provided with a display 31 is horizontally placed on the desk 20. The electronic apparatus 30 is, for example, a smart pad. The user 1 and the user 2 visually recognize the display 31, respectively, from different directions.

A screen on which a sub-area A (for example, a window) and a sub-area B are arranged is displayed on the display 31. The sub-area B is an input area for inputting, for example, characters, numerical values, and the like. In contrast, the sub-area A is a reference area in which displayed contents are changed in accordance with input contents in the sub-area B. In FIG. 8(1), the sub-area A and the sub-area B are displayed in a layout according to the design of the screen. Specifically, the sub-area A is displayed on the left side and the sub-area B is displayed on the right side. This design is made on the assumption that an operator is right-handed. In this case, a right-handed operator is not hindered from visually recognizing the sub-area A by his/her own hand performing an input operation (a touch operation) to the sub-area B, when performing the operation.

If a technique which is capable of changing the orientation of each sub-area without a positional change is applied, as illustrated in FIG. 8 (2), it is possible to change only the orientation of the sub-area A (reference area) to be suitable for visual recognition by the user 2. In such a case, the work in which the user 1 operates the sub-area B (an input area) while visually recognizing the sub-area B, and the user 2 visually recognizes the sub-area A (a reference area), is realized.

Subsequently, a case where the user 2 him/herself operates the sub-area B (an input area) is considered. In this case, as illustrated in FIGS. 9(1) and 9(2), it is possible to change the orientation of the sub-area B (input area) to be suitable for visual recognition by the user 2.

In such a case, a positional relationship between the sub-area A (reference area) and the sub-area B (input area) (see FIG. 9 (2)), specifically, a relative positional relationship between the sub-areas when seen from a direction which is suitable for visually recognizing the sub-area A (a reference area) and the sub-area B (an input area) is different from a positional relationship before the orientation change (see FIG. 8(1)). The sub-area A is on the right side and the sub-area B is on the left side in the positional relationship after the orientation change (see FIG. 9(2)), while the sub-area A is on the left side and the sub-area B is on the right side in the positional relationship before the orientation change (see FIG. 8(1)). That is, a layout after the orientation change is different from the layout (see FIG. 8(1)) which is optimized in consideration of workability or the like. In such a case, workability in a screen of FIG. 9(2) after the orientation change is deteriorated. In a case of FIG. 9(2), if the user 2 is right-handed, the user 2 is hindered from visually recognizing the sub-area A by the hand of the user 2 performing an input operation to the sub-area B, when performing the operation.

Additionally, as illustrated in FIG. 10(1), in a case where only the orientation of the sub-area A which is on a side closer to the user 1, from among the sub-area A and the sub-area B that are vertically lined up, is changed to be suitable for visual recognition by the user 2, it leads to a state as illustrated in FIG. 10(2). In this case, the user 1 visually recognizes the sub-area B and the user 2 visually recognizes the sub-area A, but a user may feel that it is easier to visually recognize a sub-area located closer to the user.

As described above, in a case of a technique of changing the orientation of each sub-area without a positional change on a screen which includes a plurality of sub-areas, a layout after changing the orientations of some of the sub-areas may become undesirable in workability, visual recognizability, or the like.

An object of the present invention is to provide a technique for achieving a desired layout of a plurality of sub-areas after changing the orientation of the sub-area in a technique capable of changing the orientation of each sub-area on a screen which includes a plurality of sub-areas.

### Solution to Problem

According to the present invention, there is provided an electronic apparatus including a display unit that displays on a display a first screen on which a plurality of sub-areas are arranged, a reception unit that receives instruction inputs to change orientations of the sub-areas included in the first screen into specified states in a unit of the sub-area, a determination unit that determines whether or not a layout of the plurality of sub-areas satisfies a first condition on a screen after the orientation of a specific one of the sub-areas which is included in the first screen is changed into the specified state without a positional change according to the instruction input, and a screen change unit that changes the orientation of the specific one of the sub-areas included in the first screen which is displayed on the display into the specified state according to the instruction input and changes the layout of the plurality of sub-areas so as to satisfy the first condition, when the determination unit determines that the first condition is not satisfied.

In addition, according to the present invention, there is provided a method of controlling an electronic apparatus, including causing a computer to execute a display step of displaying on a display a first screen on which a plurality of sub-areas are arranged, a reception step of receiving instruction inputs to change orientations of the sub-areas included in the first screen into specified states in a unit of sub-area, a determination step of determining whether or not a layout of the plurality of sub-areas satisfies a first condition on a screen after the orientation of a specific one of the sub-areas which is included in the first screen is changed into the specified state without a positional change according to the instruction input, and a screen change step of changing the orientation of the specific one of the sub-areas included in the first screen which is displayed on the display into the specified state according to the instruction input and changing the layout of the plurality of sub-areas so as to satisfy the first condition, when the determination step determines that the first condition is not satisfied.

In addition, according to the invention, there is provided a program causing a computer to function as a display unit that displays on a display a first screen on which a plurality of sub-areas are arranged, a reception unit that receives instruction inputs to change orientations of the sub-areas included in the first screen into specified states in a unit of the sub-area, a determination unit that determines whether or not a layout of the plurality of sub-areas satisfies a first condition on a screen after the orientation of a specific one of the sub areas which is included in the first screen is changed into the specified state without a positional change according to the instruction input, and a screen change unit that changes the orientation of the specific one of the sub-areas included in the first screen which is displayed on the display into the specified state according to the instruction input and changes the layout of the plurality of sub-areas so as to satisfy the first condition, when the determination unit determines that the first condition is not satisfied.

### Advantageous Effects of Invention

According to the present invention, it is possible to realize a technique for achieving a desired layout of a plurality of sub-areas after changing the orientation of a sub-area on a screen which includes a plurality of sub-areas and in which the orientation of each sub-area can be changed individually.

### BRIEF DESCRIPTION OF THE DRAWINGS

The above-described objects, other objects, features and advantages will be further apparent from the preferred exemplary embodiments described below, and the accompanying drawings as follows.

FIG. 1 is a diagram conceptually illustrating an example of a hardware configuration of an electronic apparatus according to the present exemplary embodiment.

FIG. 2 is a diagram illustrating an example of a functional block diagram of the electronic apparatus according to the present exemplary embodiment.

FIG. 3 is a flow chart illustrating an example of a flow of processing of the electronic apparatus according to the present exemplary embodiment.

FIG. 4 is a diagram illustrating an example of a functional block diagram of the electronic apparatus according to the present exemplary embodiment.

FIG. 5 is a diagram illustrating operational effects of the electronic apparatus according to the present exemplary embodiment.

FIG. 6 is a diagram illustrating operational effects of the electronic apparatus according to the present exemplary embodiment.

FIG. 7 is a diagram illustrating operational effects of the electronic apparatus according to the present exemplary embodiment.

FIG. 8 is a diagram for explaining a problem of the electronic apparatus according to the present exemplary embodiment found by the present inventor.

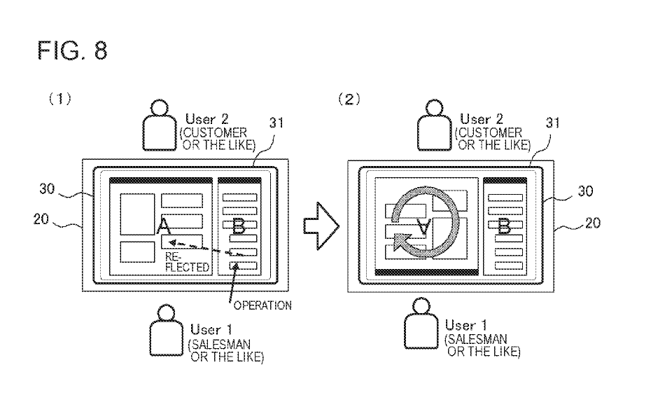

FIG. 9 is a diagram for explaining a problem of the electronic apparatus according to the present exemplary embodiment found by the present inventor.

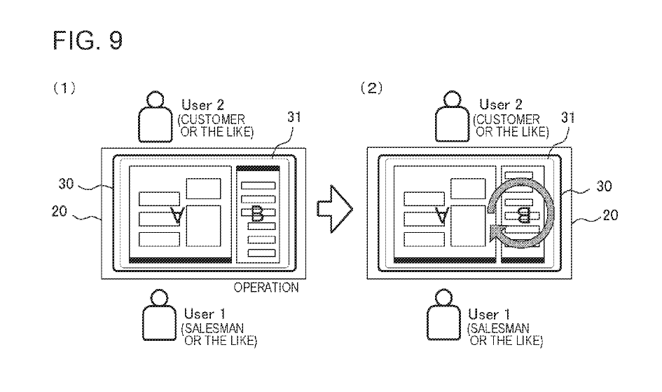

FIG. 10 is a diagram for explaining a problem of the electronic apparatus according to the present exemplary embodiment found by the present inventor.

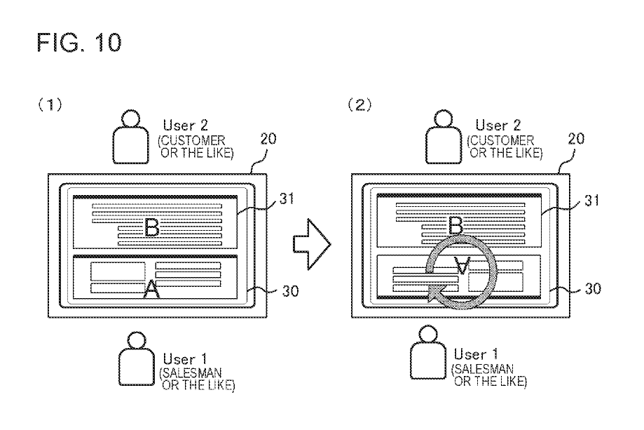

### Description of Exemplary Embodiments

First, an example of a hardware configuration of an electronic apparatus according to the present exemplary embodiment will be described.

An electronic apparatus according to the present exemplary embodiment may be a portable device or may be a stationary device. Each unit provided in the electronic apparatus according to the present exemplary embodiment is realized by any combination of hardware and software including a Central Processing Unit (CPU), a memory, a program (including a program stored in advance in the memory from the stage of shipping of an apparatus, and a program downloaded from a storage medium such as a Compact Disc (CD), a server over the Internet, or the like) which is loaded on the memory, a storage unit such as a hard disk storing the program, and an interface for network connection, which are of any computer. In addition, those skilled in the art understand that various modifications can be made to the realization method thereof and the apparatus.

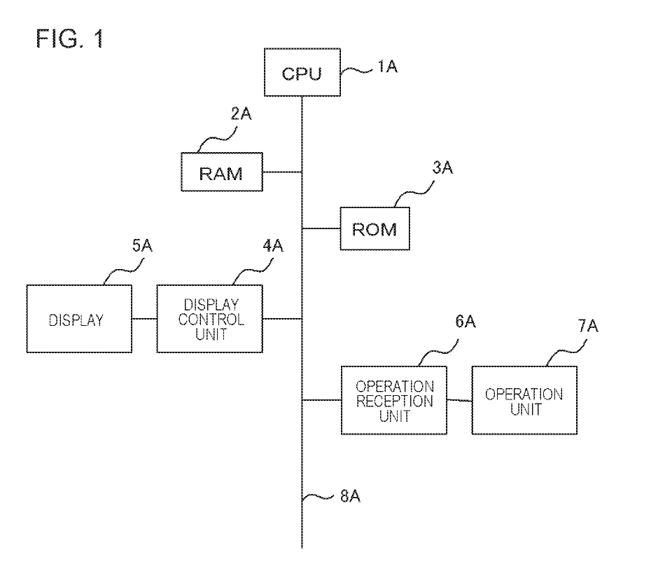

FIG. 1 is a schematic diagram conceptually illustrating an example of a hardware configuration of the electronic apparatus according to the present exemplary embodiment. As illustrated in the drawing, the apparatus according to the present exemplary embodiment includes, for example, a CPU 1A, a Random Access Memory (RAM) 2A, a Read Only Memory (ROM) 3A, a display control unit 4A, a display 5A, an operation reception unit 6A, an operation unit 7A, and the like which are connected to each other through a bus 8A. Although not illustrated in the drawing, the apparatus according to the present exemplary embodiment may include other components such as an input and output I/F connected to an external device through wired connection, a communication unit for communicating with an external device through wired connection and/or wireless connection, a microphone, a speaker, a camera, and an auxiliary storage.

The CPU 1A controls the entire computer of the electronic apparatus together with the components. The ROM 3A includes an area in which programs for operating the computer and various application programs, various pieces of setting data used when the programs operate, and the like are stored. The RAM 2A includes an area, such as a work area used for operating programs, in which data is temporarily stored.

The display 5A includes a display device (a Light Emitting Diode (LED) display, a liquid crystal display, an organic electro luminescence (EL) display, and the like). Incidentally, the display 5A may be a touch panel display integrally formed with a touch pad. The display control unit 4A reads data stored in Video RAM (VRAM), performs a predetermined process on the read data, and then transmits the data to the display 5A to perform various screen displays. The operation reception unit 6A receives various operations through the operation unit 7A. The operation unit 7A includes operation keys, operation buttons, switches, a jog dial, a touch panel display, and the like.

Hereinafter, the present exemplary embodiment will be described. Functional block diagrams used in descriptions of the following exemplary embodiments do not represent configurations of hardware units, but blocks of functional units. In the drawings, each device is described as being realized by a single device, but realization means is not limited thereto. That is, a physically divided configuration or a logically divided configuration may be adopted.

### First Exemplary Embodiment

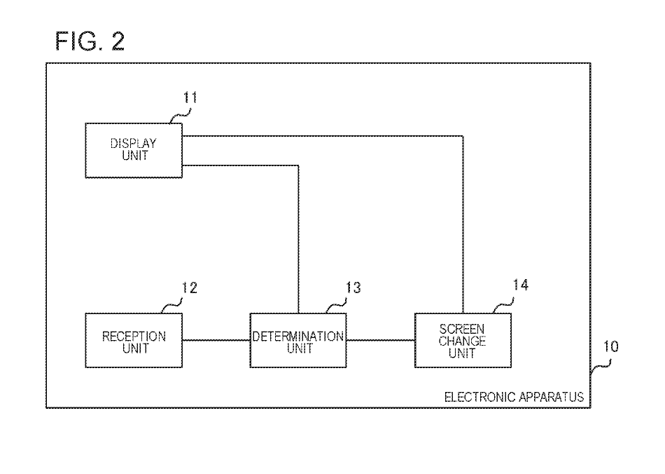

FIG. 2 is a diagram illustrating an example of a functional block diagram according to the present exemplary embodiment. As illustrated in the drawing, an electronic apparatus 10 according to the present exemplary embodiment includes a display unit 11, a reception unit 12, a determination unit 13, and a screen change unit 14.

The display unit 11 displays on a display a first screen on which a plurality of sub-areas are arranged. The first screen is a screen on which a window, a pane, or the like is arranged, and the sub-area corresponds to a window, a pane, or the like. For example, the first screen is configured by a single page, and a plurality of sub-areas are arranged within the page. The concept of the first screen includes an initial state screen on which a plurality of sub-areas are arranged in the orientation and a positional relationship that are determined in advance, and a screen on which the orientation of a single or a plurality of sub-areas and a layout of the plurality of sub-areas are changed from the initial state screen by the screen change unit 14 which will be described later.

The initial state screen is a screen on which a plurality of sub-areas are arranged in a layout which is designed by a screen designer in consideration of workability, visual recognizability, an attribute of each sub-area, or the like. The initial state screen is, for example, set as a default setting. That is, if a screen is called to be displayed on a display, at first, the initial state screen is displayed on the display.

The reception unit 12 receives instruction inputs to change orientations of the sub-areas included in the first screen into a specified state in unit of sub-area. That is, the reception unit 12 receives an input for designating a sub-area of which the orientation is to be changed and an input for designating the orientation of the sub-area after the change. Various means may be adopted as an input for designating the orientation after the change, for example, an input for designating a rotation direction (clockwise, counterclockwise, or the like), a rotation angle, and the like may be adopted. These inputs may be realized by a touch operation on a touch panel. In this case, a rotation direction and a rotation angle may be designated by a direction in which a touch position is made to slide and the amount of sliding of the touch position. These inputs are not limited to the input by the touch operation and any input technique can be applied thereto.

The determination unit 13 determines whether or not a layout of the plurality of the sub-areas satisfies a predetermined first condition on a screen after changing the orientation of a specific one of the sub-areas (a sub-area specified by an instruction input) which is included in the first screen into a specified state (a state specified by the instruction input) without a positional change according to the instruction input received by the reception unit 12. “Changing the orientation of a specific one of the sub-areas into a specified state without a positional change” corresponds to rotating a sub-area around a specified point (for example, a center point) within the sub-area to change the orientation thereof into a specified state.

Details of the first condition are a matter of design, for example, the first condition may be a condition that specifies a positional relationship between the specified sub-areas from among the plurality of the sub-areas. For example, the first condition may be a condition that specifies a relative positional relationship between sub-areas that are oriented in the same direction (details thereof will be described in a second exemplary embodiment) or a condition that specifies a degree of distribution of the sub-areas within a screen (a state where sub-areas oriented in the same direction are densely populated at a level equal to or greater than a predetermined level). Also, the first condition may be a condition that specifies a positional relationship between sub-areas that are oriented in 180-degree opposite directions with respect to each other (details thereof will be described in a third exemplary embodiment). Meanwhile, the plurality of sub-areas on the initial state screen are defined as being oriented in the same direction.

The screen change unit 14 changes the orientation of the specific one of the sub-areas (a sub-area specified by an instruction input) included in the first screen which is displayed on the display into a specified state (a state specified by an instruction input) according to the instruction input and also changes a layout of the plurality of sub-areas so as to satisfy the first condition, when the determination unit 13 determines that the first condition is not satisfied.

In contrast, when the determination unit 13 determines that the first condition is satisfied, the screen change unit 14 may change the orientation of the specific one of sub-areas (a sub-area specified by an instruction input) included in the first screen which is displayed on the display into a specified state (a state specified by an instruction input) without a positional change.

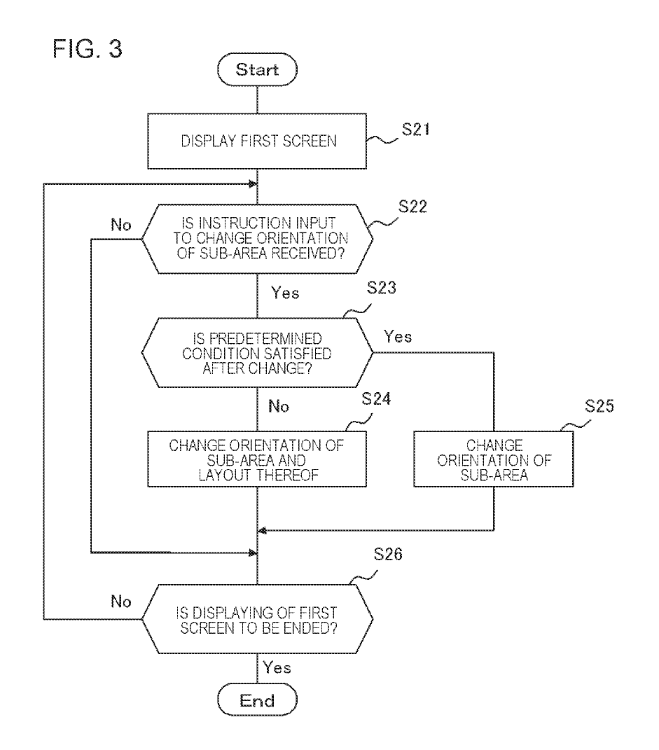

Next, an example of a flow of processing in the electronic apparatus 10 according to the present exemplary embodiment will be described with reference to a flowchart of FIG. 3.

First, the display unit 11 displays on a display a first screen on which a plurality of sub-areas are arranged (S21). Next, the reception unit 12 can receive the instruction input to change the orientation of a specific one of sub-areas included in the first screen into a specified state in unit of sub-area.

If the reception unit 12 receives the instruction input to change the orientation of a specific one of sub-areas into a specified state (Yes in S22), the determination unit 13 determines whether or not a layout of a plurality of the sub-areas satisfies a first condition on a screen after the orientation of the specific one of sub-areas which is included in the first screen is changed into the specified state without a positional change according to the instruction input.

When the determination unit 13 determines that the first condition is not satisfied (No in S23), the screen change unit 14 changes the orientation of the specific one of sub-areas included in the first screen which is displayed on the display into a specified state according to the instruction input and also changes a layout of the plurality of sub-areas so as to satisfy the first condition (S24).

In contrast, when the determination unit 13 determines that the first condition is satisfied (Yes in S23), the screen change unit 14 changes the orientation of the specific one of sub-areas included in the first screen which is displayed on the display into a specified state without a positional change (S25).

After S24 and S25 and in a case of No in S22, the process proceeds to S26. In S26, the electronic apparatus 10 determines whether or not displaying of the first screen displayed in the display is to be ended. In a case where it is determined that the displaying is not to be ended (No in S26), the electronic apparatus 10 returns to S22, and repeats the same process. In a case where it is determined that the displaying is to be ended (Yes in S26), the electronic apparatus 10 ends the process.

Hereinafter, operational effects of the present exemplary embodiment will be described.

If an instruction input to change the orientation of a specific one of sub-areas into a specified state is received, the electronic apparatus of the present exemplary embodiment determines whether or not a layout of the plurality of sub-areas satisfies a predetermined condition on a screen after the orientation of the specific one of sub-areas is changed into a specified state without a positional change according to the instruction input. When a determination result is that the predetermined condition is not satisfied, the orientation of the specific one of sub-areas is changed into a specified state according to the instruction input and also a layout of the plurality of sub-areas is changed so as to satisfy the predetermined condition. In contrast, when a determination result is that the predetermined condition is satisfied, the orientation of the specific one of sub-areas is changed into a specified state without a positional change according to the instruction input.

According to the electronic apparatus of the present exemplary embodiment, it is possible to avoid an inconvenience that the layout of the plurality of sub-areas is deviated from a desired state on a screen after the orientation in unit of sub-area is changed. As a result, it is possible to also secure sufficient workability and visual recognizability in the screen after the orientation in unit of sub-area is changed.

### Second Exemplary Embodiment

In the present exemplary embodiment, a process of changing a layout of the plurality of sub-areas so as to satisfy a predetermined condition on the screen after the orientation is changed in unit of sub-area will be described in detail.

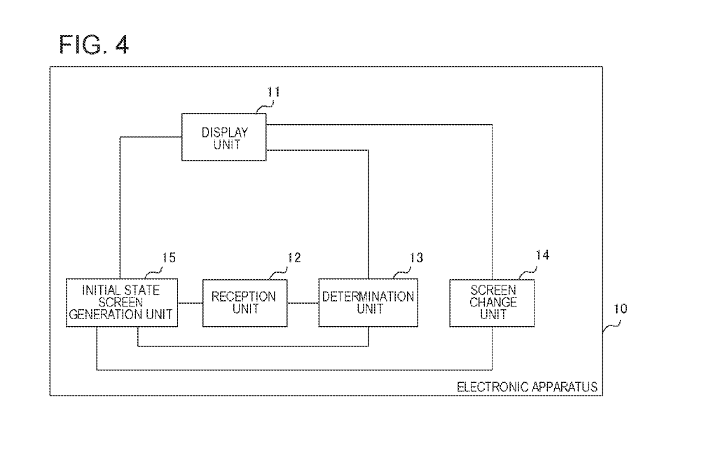

In FIG. 4, an example of a functional block diagram of the present exemplary embodiment is illustrated. As illustrated in the drawing, the electronic apparatus 10 according to the present exemplary embodiment includes the display unit 11, the reception unit 12, the determination unit 13, the screen change unit 14, and an initial state screen generation unit 15. The configurations of the display unit 11 and the reception unit 12 are the same as those in the first exemplary embodiment.

The initial state screen generation unit 15 generates an initial state screen on which a plurality of sub-areas are arranged in orientations and a positional relationship that are determined in advance. The initial state screen, as described in the first exemplary embodiment, is a screen on which a plurality of sub-areas are arranged in a layout which is designed by a screen designer in consideration of workability, visual recognizability, an attribute of each sub-area, or the like. The initial state screen generation unit 15 holds layout information for generating the initial state screen (information indicating a size, position, orientation, of each sub-area, or the like,) in advance. In addition, if an input for displaying the initial state screen on the display is performed, the initial state screen generation unit 15 generates the initial state screen in response to the input and inputs the initial state screen into the display unit 11.

Similar to the first exemplary embodiment, the determination unit 13 determines whether or not a layout of a plurality of the sub-areas satisfies a first condition on a screen after the orientation of a specific one of sub-areas which is included in the first screen is changed into a specified state without a positional change according to the instruction input. The screen change unit 14 changes the orientation of the specific one of sub-areas included in the first screen which is displayed on the display into the specified state according to the instruction input and also changes a layout of a plurality of the sub-areas so as to satisfy the first condition, when the determination unit 13 determines that the first condition is not satisfied. The configuration of the screen change unit 14 when the determination unit 13 determines that the first condition is satisfied is the same as that in the first exemplary embodiment.

The first condition in the present exemplary embodiment is that a relative positional relationship between a plurality of first sub-areas that are oriented in the same direction satisfies a condition (second condition) which is determined in advance when the first sub-areas are observed from a predetermined direction. Being oriented in the same direction may be a concept which means that the orientations of the sub-areas are completely coincident with each other, or may be a concept that includes a case where the orientations of the sub-areas are slightly different from each other (for example, a case of being inclined at plus or minus 15 degrees), in addition to a case where the orientations of the sub-areas are completely coincident with each other.

The predetermined direction (observation direction) is, for example, a direction which is suitable for visually recognizing the first sub-area, in which information included in the first sub-area is not inverted and not obliquely inclined. The predetermined direction (observation direction) is, for example, a direction from a lower end side of the sub-area toward an upper end side thereof. The lower end side of the sub-area is a side which is located close to a lower end of the initial state screen. The upper end side of the sub-area is a side which is located close to an upper end of the initial state screen.

For example, it is possible to specify that the second condition is the same as a relative positional relationship between the sub-areas when the initial state screen is observed from a predetermined direction (an observation direction suitable for visually recognizing an initial state screen). The relative positional relationship between the sub-areas on the initial state screen specified in the second condition maybe simplified to a relative positional relationship in a predetermined direction, for example, the horizontal direction, the vertical direction, or the like, in which the first sub-area is located on the left side of the second sub-area or the first sub-area is located on the upper side of the second sub-area.

An observation direction which is suitable for visual recognition of the initial state screen is an observation direction in which initial state information is not inverted and is not obliquely inclined, for example, a direction from a lower end side of the initial state screen toward the upper end side thereof. In a case where the orientation of the first sub-area is changed from the orientation in the initial state screen, a direction which is suitable for visual recognition of the first sub-area is different from a direction which is suitable for visual recognition of the initial state screen.

A layout in the initial state screen is optimized in consideration of workability, visual recognizability, and the like when observed from a predetermined direction (an observation direction which is suitable for visual recognition of the initial state screen). That is, the relative positional relationship between the plurality of sub-areas on the initial state screen is optimized such that workability and visual recognizability when observed from a predetermined direction (an observation direction which is suitable for visual recognition of the initial state screen) are improved.

In a case where the second condition as described above is satisfied, workability and visual recognizability when observed from a predetermined direction (an observation direction which is suitable for visual recognition of the first sub-area) are improved in the relative positional relationship between the first sub-areas.

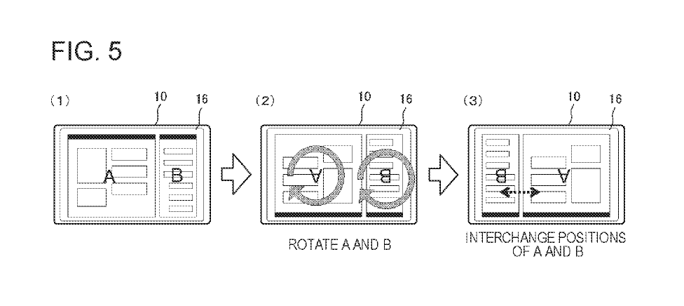

An example of the processing in the determination unit 13 and the screen change unit 14 in a case where the first condition and second condition are as the description above will be described with reference to FIG. 5.

In FIG. 5(1), an initial state screen is displayed on the display 16 included in the electronic apparatus 10. The initial state screen includes a sub-area A and a sub-area B. It is assumed that the reception unit 12 receives an instruction input to rotate each of the sub-area A and the sub-area B by 180 degrees. A screen after rotating the orientation of each of the sub-area A and the sub-area B by 180 degrees without a positional change according to the instruction input corresponds to a screen as illustrated in FIG. 5(2). In a state of FIG. 5(2), the determination unit 13 determines whether or not it is satisfied that “a relative positional relationship between a plurality of first sub-areas that are oriented in the same direction when the first sub-areas are observed from a predetermined direction (an observation direction which is suitable for visual recognition of the first sub-area) is the same as a relative positional relationship when the initial state screen is observed from a predetermined direction (an observation direction which is suitable for visual recognition of the initial state screen)” (first condition).

The observation direction which is suitable for visual recognition of the initial state screen illustrated in FIG. 5(1) is a direction from the bottom to the top in the drawing. A relative positional relationship between the sub-area A and the sub-area B when observed from the observation direction is that the sub-area A is positioned on the left side and the sub-area B is positioned on the right side.

In contrast, on a screen after the orientations of the sub-area A and the sub-area B are changed without a positional change according to the instruction input illustrated in FIG. 5(2), an observation direction which is suitable for visual recognition of the sub-area A and the sub-area B that are oriented in the same direction is a direction from the top to the bottom in the drawing. A relative positional relationship between the sub-area A and the sub-area B when observed from the observation direction is that the sub-area A is positioned on the right side and the sub-area B is positioned on the left side.

For this reason, the determination unit 13 determines that the first condition is not satisfied. The screen change unit 14 changes the layout of the sub-area A and the sub-area B so as to satisfy the first condition (see FIG. 5(3)). In a case where there are multiple layout candidates satisfying the first condition, which layout candidate the screen change unit 14 determines as a layout after the change is a matter of design.

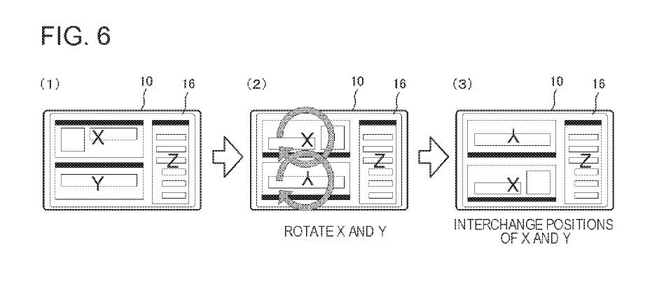

Other examples will be described with reference to FIG. 6. In FIG. 6(1), an initial state screen is displayed on the display 16 included in the electronic apparatus 10. The initial state screen includes a sub-area X, a sub-area Y, and a sub-area Z. It is assumed that the reception unit 12 receives an instruction input to rotate each of the sub-area X and the sub-area Y by 180 degrees. A screen after rotating the orientation of each of the sub-area X and the sub-area Y by 180 degrees without a positional change according to the instruction input corresponds to a screen as illustrated in FIG. 6(2). In a state of FIG. 6(2), the determination unit 13 determines whether or not it is satisfied that “a relative positional relationship between a plurality of first sub-areas that are oriented in the same direction when the first sub-areas are observed from a predetermined direction (an observation direction which is suitable for visual recognition of the first sub-area) is the same as a relative positional relationship when the initial state screen is observed from a predetermined direction (an observation direction which is suitable for visual recognition of the initial state screen)” (first condition).

The observation direction which is suitable for visual recognition of the initial state screen illustrated in FIG. 6(1) is a direction from the bottom to the top in the drawing. A relative positional relationship between the sub-area X and the sub-area Y when observed from the observation direction is that the sub-area X is positioned on the upper side and the sub-area Y is positioned on the lower side.

In contrast, an observation direction which is suitable for visual recognition of the sub-area X and the sub-area Y that are oriented in the same direction on a screen after the orientations of the sub-area X and the sub-area Y are changed without a positional change according to the instruction input, which is illustrated in FIG. 6(2) is a direction from the top to the bottom in the drawing. A relative positional relationship between the sub-area X and the sub-area Y when observed from the observation direction is that the sub-area X is positioned on the lower side and the sub-area Y is positioned on the upper side.

For this reason, the determination unit 13 determines that the first condition is not satisfied. The screen change unit 14 changes a layout of the sub-area X and the sub-area Y so as to satisfy the first condition (see FIG. 6(3)). In a case where there are multiple layout candidates satisfying the first condition, which layout candidate the screen change unit 14 determines as a layout after the change is a matter of design.

In contrast, the second condition may be specified regardless of the positional relationship between the sub-areas on the initial state screen. A single or a plurality of conditions such as, for example, “the sub-area A is on the left side of the sub-area B”, or the like may be specified in advance. In this case, it is not always necessary to specify a positional relationship of all the sub-areas (a relative positional relationship with other sub-areas) by the second condition and there may be a sub-area of which the positional relationship is completely not restricted.

According to the electronic apparatus 10 of the present exemplary embodiment described above, it is possible to realize the same operational effect as that of the first exemplary embodiment. Further, according to the electronic apparatus 10 of the present exemplary embodiment, it is possible to set the positional relationship between the plurality of sub-areas that are oriented in the same direction to a predetermined positional relationship. It is considered that the plurality of sub-areas that are oriented in the same direction corresponds to an object to be visually recognized (a work object) by the same user. Such a positional relationship between the sub-areas may be set to a predetermined positional relationship so as to secure sufficient workability and visual recognizability.

### Third Exemplary Embodiment

A functional block diagram of the electronic apparatus 10 according to the present exemplary embodiment may be similar to those in the first exemplary embodiment and the second exemplary embodiment.

Similar to the first exemplary embodiment, the determination unit 13 determines whether or not a layout of the plurality of sub-areas satisfies a first condition on a screen after the orientation of a specific one of sub-areas which is included in the first screen is changed into a specified state without a positional change according to the instruction input. The screen change unit 14 changes the orientation of the specific one of sub-areas included in the first screen which is displayed on the display into a specified state according to the instruction input and also changes a layout of the plurality of sub-areas so as to satisfy the first condition, when the determination unit 13 determines that the first condition is not satisfied. The configuration of the screen change unit 14 when the determination unit 13 determines that the first condition is satisfied is the same as that of the first exemplary embodiment.

The first condition of the present exemplary embodiment is that an upper end side of a second sub-area and an upper end side of a third sub-area face each other, in a case where an area (the second sub-area) which is oriented in a first direction and a sub-area (the third sub-area) which is oriented in a direction obtained by rotating the first direction by 180 degrees are arranged along the first direction.

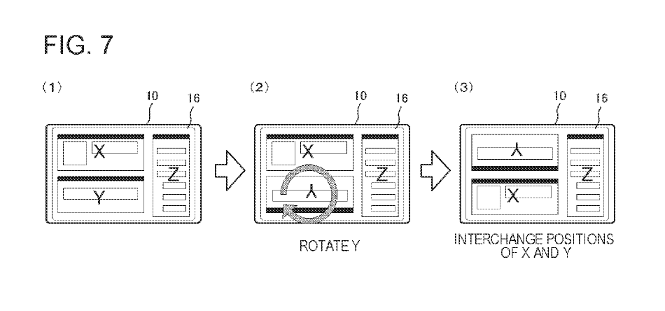

An example of the processing in the determination unit 13 and the screen change unit 14 in a case where the first condition corresponds to the description above will be described with reference to FIG. 7.

In FIG. 7 (1), an initial state screen is displayed on the display 16 included in the electronic apparatus 10. The initial state screen includes a sub-area X, a sub-area Y, and a sub-area Z. It is assumed that the reception unit 12 receives an instruction input to rotate the sub-area Y by 180 degrees. A screen after rotating the sub-area Y by 180 degrees without a positional change according to the instruction input corresponds to a screen as illustrated in FIG. 7(2). In a state of FIG. 7(2), the determination unit 13 determines whether or not it is satisfied that “in a case where a sub-area (a second sub-area) which is oriented in a first direction and a sub-area (a third sub-area) which is oriented in a direction obtained by rotating the first direction by 180 degrees are arranged along the first direction, an upper end side of the second sub-area and an upper end side of the third sub-area face each other” (a first condition). The direction to which the sub-area is directed is defined as a direction from a lower end side of the sub-area toward an upper end side thereof. The second sub-area and the third sub-area being arranged along the first direction means that the second sub-area and the third sub-area can be overlapped at least partially in a case where the second sub-area or the third sub-area is moved in the first direction.

In a state of FIG. 7(2), the sub-area X and the sub-area Y are oriented in a direction from the bottom to the top (first direction) in the drawing. The sub-area Y is oriented in a direction (a direction from the top to the bottom in the drawing) obtained by rotating the first direction by 180 degrees. In a case where the sub-area Y is moved in the first direction, the sub-area Y may overlap the sub-area X, but does not overlap the sub-area Z.

The determination unit 13 determines whether or not the upper end side of the sub-area X and the upper end side of the sub-area Y face each other. In a case of FIG. 7(2), the lower end side of the sub-area X and the lower end side of the sub-area Y face each other. Thus, the determination unit 13 determines that the first condition is not satisfied. Then, the screen change unit 14 changes the layout of the sub-area X and the sub-area Y so as to satisfy the first condition (see FIG. 7(3)). In a case where there are multiple layout candidates satisfying the first condition, which layout candidate the screen change unit 14 determines as a layout after the change is a matter of design.

According to the electronic apparatus 10 of the present exemplary embodiment as described above, it is possible to achieve the same operational effect as those of the first exemplary embodiment and the second exemplary embodiment. According to the electronic apparatus 10 of the present exemplary embodiment, a layout may be achieved in which the upper end sides of the sub-areas which are oriented in 180-degree opposite directions with respect to each other and are arranged linearly face with each other. In this manner, in a case where the plurality of sub-areas that are oriented in 180-degree opposite directions are arranged linearly, each sub-area can be brought closer to the outer circumference portion of the display 16 located on the lower end side of the sub-area. The outer circumference portion corresponds to a position (a direction of the lower-end of the sub-area) which is suitable for visual recognition of the sub-area. For this reason, each sub-area is located near the user who is located in a position (a direction of the lower-end of the sub-area) which is suitable for visual recognition of the sub-area.

Hereinafter, an example of a reference configuration will be appended.

1. An electronic apparatus comprising:

a display unit that displays on a display a first screen on which a plurality of sub-areas are arranged;

a reception unit that receives instruction inputs to change orientations of the sub-areas included in the first screen into specified states in a unit of the sub-area;

a determination unit that determines whether or not a layout of the plurality of sub-areas satisfies a first condition on a screen after the orientation of a specific one of the sub-areas which is included in the first screen is changed into the specified state without a positional change according to the instruction input; and

a screen change unit that changes the orientation of the specific one of the sub-areas included in the first screen which is displayed on the display into the specified state according to the instruction input and changes the layout of the plurality of sub-areas so as to satisfy the first condition, when the determination unit determines that the first condition is not satisfied.

2. The electronic apparatus according to 1,

wherein the first condition is that a relative positional relationship observed from a predetermined direction between a plurality of first sub-areas that are oriented in the same direction satisfies a second condition which is determined in advance.

3. The electronic apparatus according to 2, further comprising:

an initial state screen generation unit that generates an initial state screen on which the plurality of sub-areas are arranged in orientations and a positional relationship that are determined in advance,

wherein the first condition is that the relative positional relationship between the first sub-areas is same as a relative positional relationship between the first sub-areas when the initial state screen is observed from a predetermined direction.

4. The electronic apparatus according to 1,

wherein the first condition is that an upper end side of a second sub-area and an upper end side of a third sub-area face each other in a case where the second sub-area which is oriented in a first direction and the third sub-area which is oriented in a direction obtained by rotating the first direction by 180 degrees are arranged along the first direction.

5. The electronic apparatus according to any one of 1 to 4,

wherein the screen change unit changes the orientation of the specific one of the sub-areas included in the first screen which is displayed on the display into the specified state without a positional change when the determination unit determines that the first condition is satisfied.

6. A method of controlling an electronic apparatus executed by a computer, comprising:

a display step of displaying on a display a first screen on which a plurality of sub-areas are arranged;

a reception step of receiving instruction inputs to change orientations of the sub-areas included in the first screen into specified states in a unit of sub-area;

a determination step of determining whether or not a layout of the plurality of sub-areas satisfies a first condition on a screen after the orientation of a specific one of the sub-areas which is included in the first screen is changed into the specified state without a positional change according to the instruction input; and

a screen change step of changing the orientation of the specific one of the sub-areas included in the first screen which is displayed on the display into the specified state according to the instruction input and changing the layout of the plurality of sub-areas so as to satisfy the first condition, when the determination step determines that the first condition is not satisfied.

6-2. The method according to 6,

wherein the first condition is that a relative positional relationship observed from a predetermined direction between a plurality of first sub-areas that are oriented in the same direction satisfies a second condition which is determined in advance.

6-3. The method according to 6-2, causing the computer to further execute:

an initial state screen generation step of generating an initial state screen on which the plurality of sub-areas are arranged in orientations and a positional relationship that are determined in advance,

wherein the first condition is that the relative positional relationship between the first sub-areas is same as a relative positional relationship between the first sub-areas when the initial state screen is observed from a predetermined direction.

6-4. The method according to 6,

wherein the first condition is that an upper end side of a second sub-area and an upper end side of a third sub-area face each other in a case where the second sub-area which is oriented in a first direction and the third sub-area which is oriented in a direction obtained by rotating the first direction by 180 degrees are arranged along the first direction.

6-5. The method according to any one of 6 to 6-4,

wherein the screen change step includes changing the orientation of the specific one of the sub-areas included in the first screen which is displayed on the display into the specified state without a positional change when the determination step determines that the first condition is satisfied.

7. A program causing a computer to function as:

a display unit that displays on a display a first screen on which a plurality of sub-areas are arranged;

a reception unit that receives instruction inputs to change orientations of the sub-areas included in the first screen into specified states in a unit of the sub-area;

a determination unit that determines whether or not a layout of the plurality of sub-areas satisfies a first condition on a screen after the orientation of a specific one of the sub areas which is included in the first screen is changed into the specified state without a positional change according to the instruction input; and

a screen change unit that changes the orientation of the specific one of the sub-areas included in the first screen which is displayed on the display into the specified state according to the instruction input and changes the layout of the plurality of sub-areas so as to satisfy the first condition, when the determination unit determines that the first condition is not satisfied.

7-2. The program according to 7,

wherein the first condition is that a relative positional relationship observed from a predetermined direction between a plurality of first sub-areas that are oriented in the same direction satisfies a second condition which is determined in advance.

7-3. The program according to 7-2, causing the computer to further function as an initial state screen generation unit that generates an initial state screen on which the plurality of sub-areas are arranged in orientations and a positional relationship that are determined in advance,

wherein the first condition is that the relative positional relationship between the first sub-areas is same as a relative positional relationship between the first sub-areas when the initial state screen is observed from a predetermined direction.

7-4. The program according to 7,

wherein the first condition is that an upper end side of a second sub-area and an upper end side of a third sub-area face each other in a case where the second sub-area which is oriented in a first direction and the third sub-area which is oriented in a direction obtained by rotating the first direction by 180 degrees are arranged along the first direction.

7-5. The program according to any one of 7 to 7-4,

wherein the program causes the screen change unit to change the orientation of the specific one of the sub-areas included in the first screen which is displayed on the display into the specified state without a positional change when the determination unit determines that the first condition is satisfied.

The application is based on Japanese Patent Application No. 2013-208808 filed on Oct. 4, 2013, the content of which is incorporated herein by reference.

1. An electronic apparatus comprising:
a display unit that displays on a display a first screen on which a plurality of sub-areas are arranged;
a reception unit that receives instruction inputs to change orientations of the sub-areas included in the first screen into specified states in a unit of the sub-area;
a determination unit that determines whether or not a layout of the plurality of sub-areas satisfies a first condition on a screen after the orientation of a specific one of the sub-areas which is included in the first screen is changed into the specified state without a positional change according to the instruction input; and
a screen change unit that changes the orientation of the specific one of the sub-areas included in the first screen which is displayed on the display into the specified state according to the instruction input and changes the layout of the plurality of sub-areas so as to satisfy the first condition, when the determination unit determines that the first condition is not satisfied.

2. The electronic apparatus according to claim 1,
wherein the first condition is that a relative positional relationship observed from a predetermined direction between a plurality of first sub-areas that are oriented in the same direction satisfies a second condition which is determined in advance.

3. The electronic apparatus according to claim 2, further comprising:
an initial state screen generation unit that generates an initial state screen on which the plurality of sub-areas are arranged in orientations and a positional relationship that are determined in advance,
wherein the first condition is that the relative positional relationship between the first sub-areas is same as a relative positional relationship between the first sub-areas when the initial state screen is observed from a predetermined direction.

4. The electronic apparatus according to claim 1,
wherein the first condition is that an upper end side of a second sub-area and an upper end side of a third sub-area face each other in a case where the second sub-area which is oriented in a first direction and the third sub-area which is oriented in a direction obtained by rotating the first direction by 180 degrees are arranged along the first direction.

5. The electronic apparatus according to claim 1,
wherein the screen change unit changes the orientation of the specific one of the sub-areas included in the first screen which is displayed on the display into the specified state without a positional change when the determination unit determines that the first condition is satisfied.

6. A method of controlling an electronic apparatus executed by a computer, comprising:
a display step of displaying on a display a first screen on which a plurality of sub-areas are arranged;
a reception step of receiving instruction inputs to change orientations of the sub-areas included in the first screen into specified states in a unit of sub-area;
a determination step of determining whether or not a layout of the plurality of sub-areas satisfies a first condition on a screen after the orientation of a specific one of the sub-areas which is included in the first screen is changed into the specified state without a positional change according to the instruction input; and
a screen change step of changing the orientation of the specific one of the sub-areas included in the first screen which is displayed on the display into the specified state according to the instruction input and changing the layout of the plurality of sub-areas so as to satisfy the first condition, when the determination step determines that the first condition is not satisfied.

7. A non-transitory storage medium storing a program causing a computer to function as:
a display unit that displays on a display a first screen on which a plurality of sub-areas are arranged;
a reception unit that receives instruction inputs to change orientations of the sub-areas included in the first screen into specified states in a unit of the sub-area;
a determination unit that determines whether or not a layout of the plurality of sub-areas satisfies a first condition on a screen after the orientation of a specific one of the sub areas which is included in the first screen is changed into the specified state without a positional change according to the instruction input; and
a screen change unit that changes the orientation of the specific one of the sub-areas included in the first screen which is displayed on the display into the specified state according to the instruction input and changes the layout of the plurality of sub-areas so as to satisfy the first condition, when the determination unit determines that the first condition is not satisfied.
